(19) United States
(12) Patent Application Publication
(10) Pub. No.: US 2008/0274040 A1
(43) Pub. Date: Nov. 6, 2008

(54) Injector assembly, chemical reactor and chemical process

(75) Inventors: Harry Eugene Flynn, Edmond, OK (US); Robert O. Martin, Edmond, OK (US); Charles A. Natalie, Edmond, OK (US)

Correspondence Address: Clifford C. Dougherty, III;McAfee & Taft, Tenth Floor, Two Leadership Square, 211 North Robinson, Oklahoma City, OK, 73102, US

(73) Assignee: Tronox LLC

(21) Appl. No.: 11/799,875

(22) Filed: May 3, 2007

(51) Int. Cl. C01G 23/07; B01J 19/00; B01L 11/00

(52) U.S. Cl. 423/612; 422/129; 422/99; 423/611

(57) ABSTRACT

An injector assembly for injecting an additional component into a component stream flowing through a reactor conduit along the longitudinal axis thereof. A chemical reactor including an injector assembly for injecting an additional component into a moving component stream and a chemical process are also provided. In one embodiment, the chemical process is a process for producing titanium dioxide.

### BACKGROUND OF THE INVENTION

Chemical reactors that include an elongated reactor conduit such as a tubular reactor conduit for receiving reactants and allowing the reactants to mix and react on a continuous basis are well known. In such a reactor, a reactant stream is initiated and caused to flow along the longitudinal axis of the reactor conduit as the reaction is carried out. Reactants and other components can be injected into the moving reactant stream at various points in the reactor conduit. The reacted product is separated from other components (which are often recycled) and recovered.

Injecting a reactant or other component into a moving reactant stream in a manner that allows the component to thoroughly mix with the other components in the stream can be difficult, for example, when the stream is moving at a relatively high velocity. Injection of the component around the perimeter of the moving stream often creates a slip stream of the component along the inside wall of the reactor conduit. As a result, the component does not significantly penetrate the outer boundary layer of the main reactant stream and mix with the components therein. If the reactant is corrosive, damage can result to the reactor conduit wall.

A commercially significant example of a process wherein these issues are encountered is the manufacture of titanium dioxide by the chloride process. In such a process, streams of gaseous titanium halide (such as titanium tetrachloride) and oxygen are heated and introduced at high flow rates into an elongated vapor phase oxidation reactor conduit. A high temperature (approximately 2000° F. to 2800° F.) oxidation reaction takes place in the reactor conduit whereby particulate solid titanium dioxide and gaseous reaction products are produced. The titanium dioxide and gaseous reaction products are then cooled, and the titanium dioxide particles are recovered. The solid titanium dioxide is very useful as a pigment.

In order to increase the capacity of a chloride process for producing titanium dioxide, a second reaction zone can be created in the reactor conduit downstream of the first reaction zone therein. Pre-heated titanium tetrachloride and/or oxygen can be added to the second reaction zone to react with oxygen and/or titanium tetrachloride from the first reaction zone. Unfortunately, due to the velocity at which the main reactant stream is moving through the reactor conduit, it can be difficult to inject the additional reactant in a manner that causes it to significantly penetrate beyond the outer boundary layer of the main reactant stream. The additional reactant is typically forced along the inside wall of the reactor and does not sufficiently penetrate and mix with the main reactant stream. If the additional reactant is titanium tetrachloride, corrosion to the reactor wall can occur.

### SUMMARY OF THE INVENTION

In one aspect, the invention provides an injector assembly for injecting an additional component into a component stream flowing through the conduit opening of a reactor conduit along the longitudinal axis thereof. The injector assembly is attachable between the downstream end of a first section of the reactor conduit and the upstream end of a second section of the reactor conduit in a manner that fluidly connects the first and second sections of the reactor conduit together.

The injector assembly comprises an injector conduit having an upstream end, a downstream end and an injector conduit wall disposed between the upstream end and the downstream end. The injector conduit wall defines an injector conduit opening that can be aligned to be in fluid communication with the conduit openings of the first and second sections of the reactor conduit. The injector conduit wall includes at least one port extending therethrough for transversely injecting the additional component into the component steam in the reactor conduit. An outer chamber extends around the outside of the injector conduit wall along the cross-sectional perimeter thereof and is in fluid communication with the port. The outer chamber includes an inlet for receiving the additional component from a source of the additional component.

In another aspect, the invention provides a chemical reactor. The reactor comprises a reactor conduit for conducting a component stream in a flow path that is substantially parallel to the longitudinal axis of the conduit, and an injector assembly for injecting an additional component into the component stream. The reactor conduit includes a first section and a second section, each of the first and second sections having an upstream end, a downstream end and a reactor conduit wall defining a reactor conduit opening disposed between the upstream and downstream ends.

The injector assembly of the reactor is disposed between the downstream end of the first section of the reactor conduit and the upstream end of the second section of the reactor conduit, and fluidly connects the first and second sections together. The injector assembly includes an injector conduit and an outer chamber. The injector conduit has an upstream end, a downstream end and an injector conduit wall disposed between the upstream end and the downstream end and defining an injector conduit opening. The injector conduit opening is aligned with the conduit openings of the first and second sections of the reactor conduit and in fluid communication therewith. The injector conduit wall includes at least one port extending therethrough for transversely injecting the additional component into the component stream.

The outer chamber of the reactor extends around the injector conduit wall along the cross-sectional perimeter thereof and is in fluid communication with the port. The outer chamber includes an inlet for receiving the additional component from a source of the additional component.

In another aspect, the invention provides a chemical process. In accordance with the process, one or more components are introduced into a reactor conduit in a manner that causes the component(s) to flow as a component stream through the reactor conduit along the longitudinal axis thereof. An additional component is transversely injected into the component stream through a plurality of ports spaced around the cross-sectional perimeter of the reactor conduit. The additional component is injected through the ports at a velocity sufficient to cause the additional component to significantly penetrate the outer boundary layer of the component stream.

In one embodiment, the inventive chemical process is a process for producing titanium dioxide. Gaseous titanium halide (for example, titanium tetrachloride) and oxygen are introduced into a first reaction zone of a reactor conduit of a reactor in a manner that causes the titanium halide and oxygen to flow as a reactant stream through the reactor conduit along the longitudinal axis thereof. An additional component chosen from gaseous titanium halide, oxygen and a mixture thereof is introduced into a second reaction zone in the reactor conduit that is downstream of the first reaction zone. The additional component is transversely injected into the reactant stream from a plurality of ports spaced around the cross-sectional perimeter of the reactor conduit at a sufficient velocity to cause the additional component to significantly penetrate the outer boundary layer of the reactant stream. Titanium halide and oxygen are allowed to react in the vapor phase in the first and/or second reaction zones of the reactor conduit to form titanium dioxide particles and gaseous reaction products. The titanium dioxide particles are then separated from the gaseous reaction products.

### BRIEF DESCRIPTION OF THE DRAWINGS

FIG. 1 is a rear perspective view of an embodiment of the inventive injector assembly.

FIG. 2 is a front perspective view of the embodiment of the inventive injector assembly shown by FIG. 1.

FIG. 3 is an end view of the embodiment of the inventive injector assembly shown by FIGS. 1 and 2.

FIG. 4 is a rear view of the inventive injector assembly shown by FIGS. 1-3.

FIG. 5 is a cross-sectional view taken along line 5-5 in FIG. 3.

FIG. 6 is a cross-sectional view taken along line 6-6 in FIG. 4.

FIG. 7 is a sectional view of an embodiment of the inventive reactor.

FIG. 7A is a cross-sectional view taken along line 7A-7A of FIG. 7.

FIG. 8 is a sectional view of an embodiment of the inventive reactor that includes two of the inventive injector assemblies positioned directly adjacent to one another.

FIG. 9 is a sectional view of an embodiment of the inventive reactor that includes two of the inventive injector assemblies positioned in a spaced relationship with respect to each other.

FIG. 10 is a schematic drawing illustrating an embodiment of the inventive process for producing rutile titanium dioxide.

FIG. 11 includes a sectional view of an embodiment of the inventive reactor as used in the inventive process for producing rutile titanium dioxide together with a diagrammatical representation of associated component pre-heat assemblies.

FIG. 12 is a diagrammatic view corresponding to Example 1 and illustrating the degree of component penetration achieved by the inventive injector assembly and reactor.

### DETAILED DESCRIPTION

The invention includes an injector assembly, a chemical reactor and a chemical process. In one embodiment, the chemical process is a process for producing titanium dioxide.

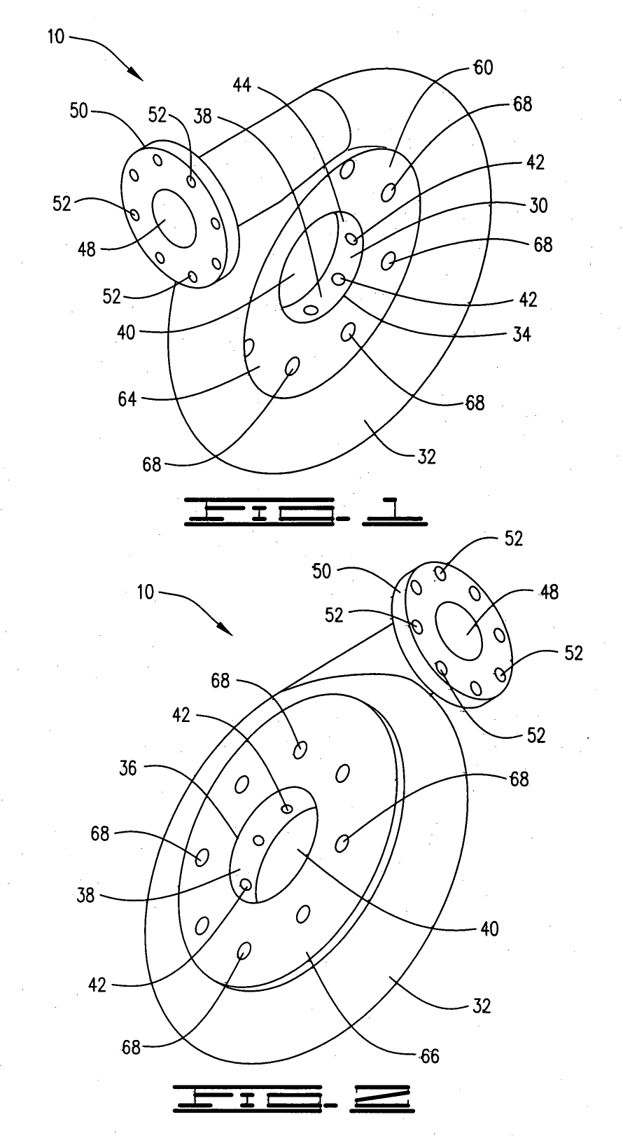

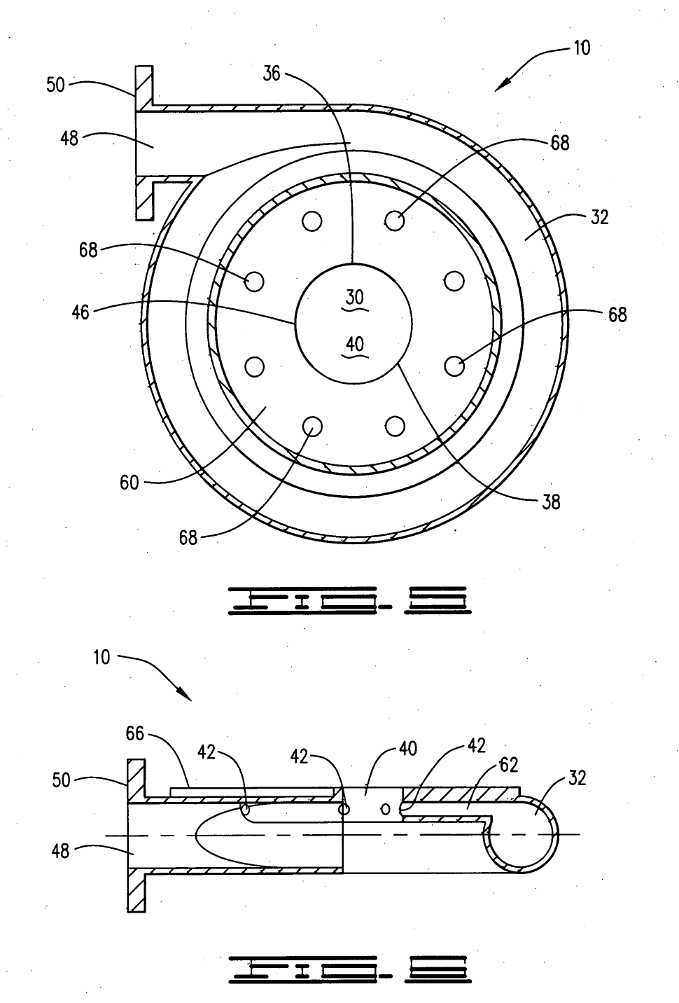

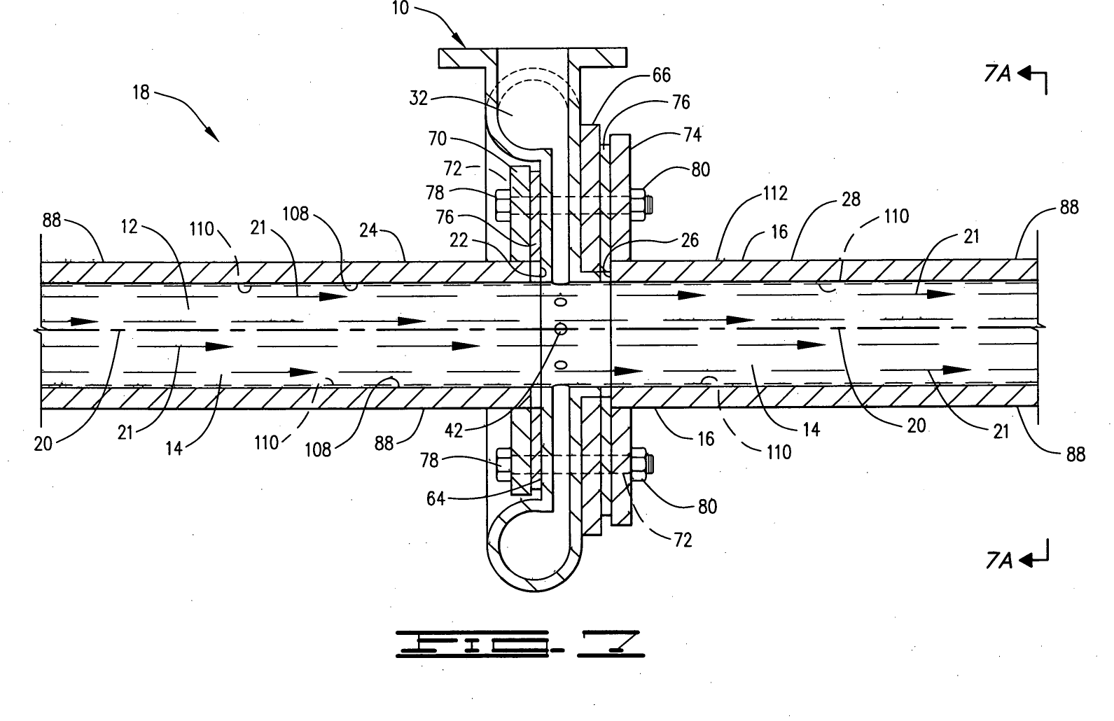

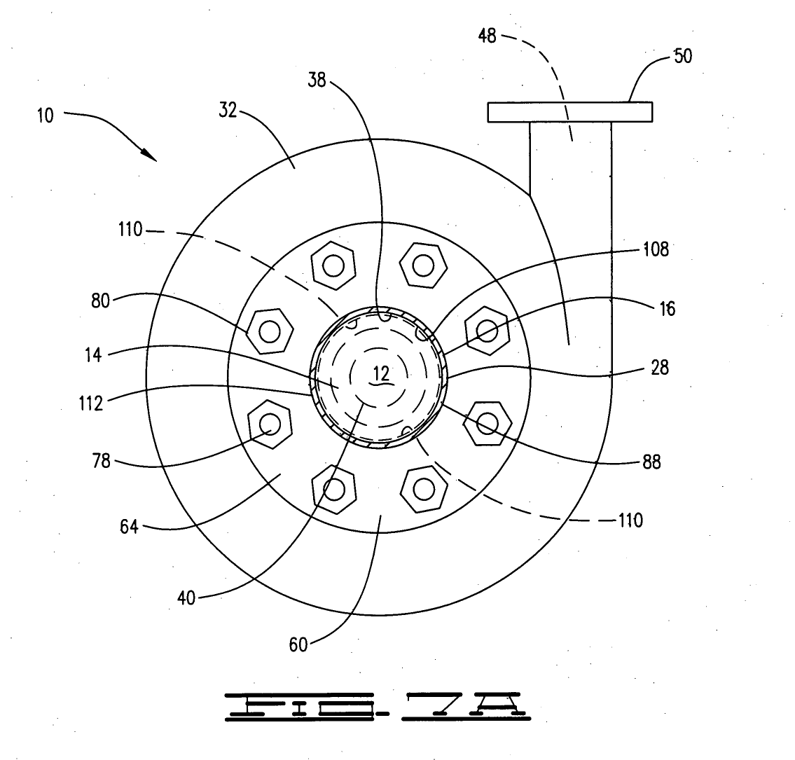

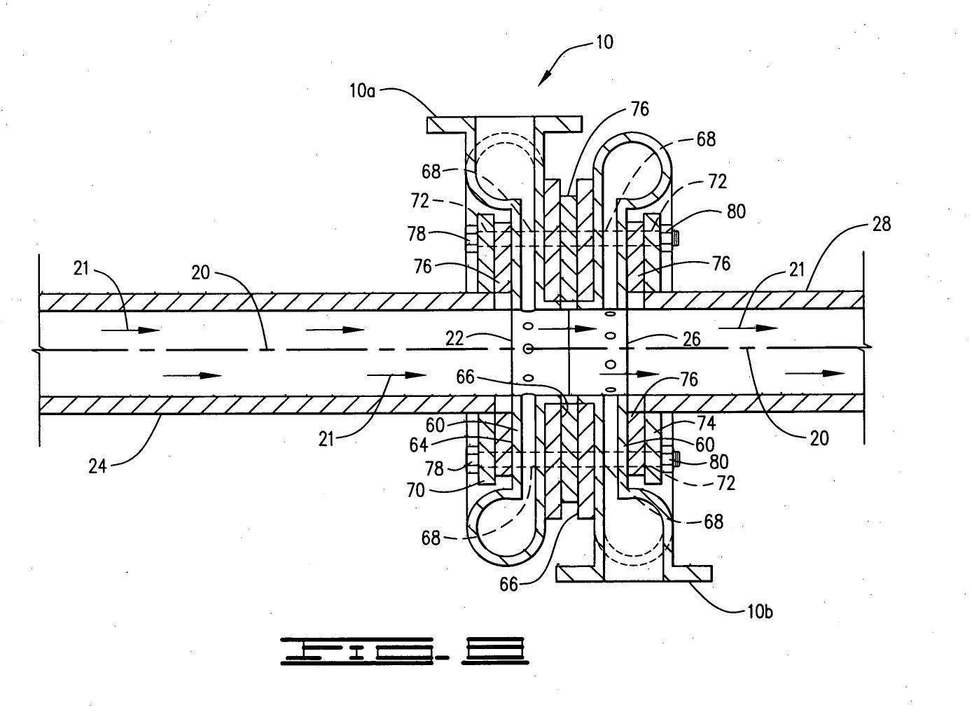

Referring now to FIGS. 1-7, the inventive injector assembly is illustrated and generally designated by the reference numeral 10. The intended use of the injector assembly 10 is illustrated by FIG. 7. As shown, the injector assembly 10 is for injecting an additional component (not shown) into a component stream 12 flowing through the conduit opening 14 of a reactor conduit 16 of a reactor 18 along the longitudinal axis 20 of the reactor conduit. As shown by FIG. 7, the component stream 12 is flowing in the direction indicated by arrows 21. The injector assembly 10 is attachable between the downstream end 22 of a first section 24 of the reactor conduit 16 and the upstream end 26 of a second section 28 of the reactor conduit in a manner that fluidly connects the first and second sections of the reactor conduit together.

The additional component injected into the component stream 12 can be a single reactant or other component or a combination of reactants and/or other components in vapor, liquid or slurry form. Similarly, the component stream can comprise one or more reactants or other components in vapor, liquid or slurry form. A primary use of the inventive injector assembly 10 is to inject gaseous components into a moving gaseous component stream. For example, as described below, the inventive injector assembly 10 can be used to inject additional titanium halide vapor or oxygen into a moving titanium halide/oxygen vapor reactant stream to thereby form a second reaction zone in a process for producing titanium dioxide.

Referring now in particular to FIGS. 1-6, the injector assembly 10 comprises an injector conduit 30 and an outer chamber 32. The injector conduit 30 has an upstream end 34, a downstream end 36 and an injector conduit wall 38. The injector conduit wall 38 is disposed between the upstream end 34 and the downstream end 38 of the injector conduit 30 and defines an injector conduit opening 40 that can be aligned to be in fluid communication with the conduit openings 14 of the first and second sections 24 and 28 of the reactor conduit 16. For example, as shown by FIG. 7, the injector conduit opening 40 can be axially aligned with the conduit openings 14 of the first and second sections 24 and 28 of the reactor conduit 16 such that the injector conduit 30 and first and second sections of the reactor conduit are aligned together in a straight path (or at least an approximately straight path).

The injector conduit wall 38 includes a plurality of ports 42 spaced around the cross-sectional perimeter 44 of the injector conduit wall and extending through the injector conduit wall for transversely injecting the additional component into the component stream 12 in the reactor conduit 16. As shown in the drawings, the ports 42 are equally spaced (or at least approximately equally spaced) around the cross-sectional perimeter 44 of the conduit wall 38.

As used herein and in the appended claims, the cross-sectional perimeter of the reactor conduit 16 (or the injector conduit wall 38, as the case may be) means the perimeter of the reactor conduit 16 (or the injector conduit wall 38) that extends perpendicularly (or at least approximately perpendicularly) with respect to the longitudinal axis 20 of the reactor conduit 16 (when the injector assembly 10 is disposed between the first and second sections 24 and 28 of the reactor conduit as shown by FIG. 7, in the case of the injector conduit wall 38). Transversely injecting the additional component into the component stream 12 means injecting the additional component into the component stream 12 at an angle with respect to the longitudinal axis 20 of the reactor conduit 16 (and hence the longitudinal axis of the component stream 12) (when the injector assembly 10 is disposed between the first and second sections 24 and 28 of the reactor conduit as shown by FIG. 7, in the case of the injector assembly 10), the angle being in the range from about 30° to about 90°. In order to assure significant penetration into the outer boundary layer of the component stream 12, the closer the angle at which the additional component is injected into the component stream 12 with respect to the longitudinal axis 20 of the reactor conduit 16 (and hence the longitudinal axis of the component stream 12) is to 90° the better. As shown by the drawings, the chemical reactor 18 is set up to inject the additional component into the component stream 12 at an angle with respect to the longitudinal axis 20 of the reactor conduit 16 (and hence the longitudinal axis of the component stream 12) of about 90°.

The outer chamber 32 extends around the outside surface 46 of the injector conduit wall 38 along the cross-sectional perimeter 44 thereof and is in fluid communication with the ports 42. The outer chamber 32 includes an inlet 48 for receiving the additional component to be injected into the component stream 12 from a source of the additional component (not shown). The inlet 48 includes a flange 50 and corresponding openings 52 for allowing the flange to be attached (for example, bolted) to a corresponding flange of a conduit or other structure conducting the component to the inlet (not shown).

A spacer plate 60 is disposed between the injector conduit 30 and the outer chamber 32. As shown by the drawings, the length of the spacer plate 60 and the length of the injector conduit 16 are the same. As used herein and in the appended claims, the length of each of the spacer plate and injector conduit means the dimension of the component that extends along the longitudinal axis 20 of the reactor conduit 16 (when the injector assembly 10 is disposed between the first and second sections 24 and 28 of the reactor conduit as shown by FIG. 7, in the case of the injector assembly 10). As best shown by FIG. 4, the spacer plate 60 includes a passageway 62 disposed between each of the ports 42 and the outer chamber 32. Each passageway 62 fluidly connects the corresponding port 42 and the outer chamber 32 together.

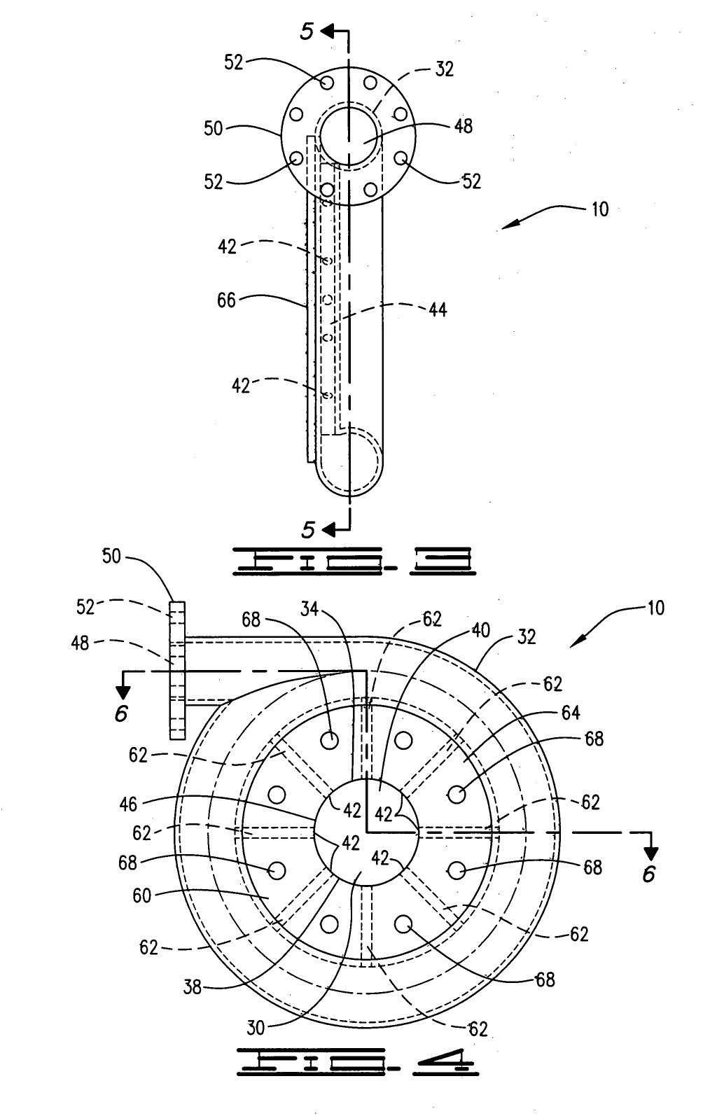

The spacer plate 60 allows the injector assembly 10 to be easily attached between the first and second sections 24 and 28, respectively, of the reactor conduit 16. The spacer plate 60 includes a rear surface 64 and an opposing front surface 66. The rear surface 64 of the spacer plate 60 is inset with respect to the outer chamber 32 (as shown by FIG. 1), whereas the front surface 66 of the spacer plate extends outwardly with respect to the outer chamber (as shown by FIG. 2). The inset nature of the rear surface 64 and outward extension of the front surface 66 of the spacer plate 60 with respect to the outer chamber 32 allows two injector assemblies to be easily bolted together back to back as shown by FIG. 8.

A plurality of openings 68 extend through the spacer plate 60 from the rear surface 64 to the front surface 66 of the plate. As shown by FIG. 7, the first section 24 of the reactor conduit 16 includes a flange 70 having a plurality of openings 72 therein. Similarly, the second section 28 of the reactor conduit 16 includes a flange 74 having a plurality of openings 72 therein. The flange 70 of the first section 24 of the reactor conduit 16 can be attached to the rear surface 64 of the spacer plate 60, and the flange 74 of the second section 28 of the reactor conduit can be attached to the front surface 66 of the spacer plate. Gaskets 76 can be disposed between each of the flanges 70 and 74 and the spacer plate 60 to assure a proper seal. Bolts 78 can be extended through the openings 72 in the flange 70, corresponding openings 68 in the spacer plate 60 and corresponding openings 72 in the flange 74, and nuts 80 can be threaded on to the bolts to attach the first and second sections 24 and 28 of the reactor conduit 16 to the spacer plate and indirectly together. In this manner, the first and second sections 24 and 28 of the reactor conduit 16 can be fluidly connected to the injector assembly 10 and indirectly fluidly connected together. The first and second sections 24 and 28 of the reactor conduit 16 and the injector conduit 30 effectively become a single reactor conduit with the ports 42 spaced around the cross-sectional perimeter of the reactor conduit.

As shown by the drawings, the injector conduit 30 (and hence the injector conduit opening 40) and the spacer plate 60 have circular cross-sectional shapes. The circular cross-sectional shapes make the injector assembly 10 particularly suitable for use in association with tubular reactor conduits. However, the injector conduit 30 (and hence the injector conduit opening 40) and the spacer plate 60 can have other cross-sectional shapes as well. Non-limiting examples include oval, square and other polygonal cross-sectional shapes.

As shown in the drawings, the outer chamber 32 is a conduit that has a circular cross-sectional shape. However, the outer chamber 32 can have other cross-sectional shapes as well. Non-limiting examples include oval, square and other polygonal cross-sectional shapes.

Referring now to FIGS. 7-9 and 11, the inventive chemical reactor is illustrated and generally designated by the reference numeral 18. The reactor comprises a reactor conduit 16 for conducting a component stream 12 in a flow path that is parallel (or at least approximately parallel) to the longitudinal axis 20 of the reactor conduit. The reactor conduit 16 includes a first section 24 and a second section 28, each of the first and second sections having a downstream end 22, an upstream end 26, and a reactor conduit wall 88 defining a reactor conduit opening 14 disposed between the upstream ends and downstream ends.

The inventive reactor 18 further comprises the inventive injector assembly 10, as described above and illustrated in the drawings, for injecting an additional component (not shown) into the component stream 12. The injector assembly 10 is disposed between the downstream end 22 of the first section 24 of the reactor conduit 16 and the upstream end 26 of the second section 28 of the reactor conduit, and fluidly connects the first and second sections of the reactor conduit together. As shown in the drawings, the flange 70 of the first section 24 of the reactor conduit 16 is attached to the rear surface 64 of the spacer plate 60, and the flange 74 of the second section 28 of the reactor conduit is attached to the front surface 66 of the spacer plate. Gaskets 76 are disposed between each of the flanges 70 and 74 and the spacer plate 60 to assure a proper seal. Bolts 78 are extended through the openings 72 in the flange 70, corresponding openings 68 in the spacer plate 60 and corresponding openings 72 in the flange 74, and nuts 80 are threaded on to the bolts to attach the first and second sections 24 and 28 of the reactor conduit 16 to the spacer plate and indirectly together.

The injector conduit opening 40 of the injector conduit 30 of the injector assembly 10 is aligned with the reactor conduit openings 14 of the first section 24 and second section 28 of the reactor conduit 16 and in fluid communication therewith. In this manner, the first and second sections 24 and 28 of the reactor conduit 16 and the injector conduit 30 are effectively a single reactor conduit with the ports 42 spaced around the cross-sectional perimeter 44 of the reactor conduit. As shown by the drawings, the reactor conduit 16 including the first and second sections 24 and 28 thereof and the injector conduit 30 are axially aligned together in a straight path (or at least an approximately straight path). As shown by the drawings, the reactor conduit 16 (including the first and second sections 24 and 28) and hence the reactor conduit opening 14 thereof as well as the injector conduit 30 and the injector conduit opening 40 each have a circular cross-sectional shape. As shown, the diameters of the reactor conduit opening 14 and the injector conduit opening 40 are the same or at least approximately the same. The outer chamber 32 is a conduit extending around the outside surface 46 of the injector conduit wall 38 along the cross-sectional perimeter 44 thereof and around the spacer plate in a direction that is perpendicular or at least approximately perpendicular to the longitudinal axis 20 of the reactor conduit 16.

If desired, the reactor 18 can include a series of injector assemblies 10 to inject one or more components into the component stream 12 in the reactor conduit 16 if desired. For example, as shown by FIG. 8, two injector assemblies 10a and 10b are disposed directly adjacent to each other between the downstream end 22 of the first section 24 of the reactor conduit and the upstream end 26 of the second section 28 of the reactor conduit. The flange 70 of the first section 24 of the reactor conduit 16 is attached to the rear surface 64 of the spacer plate 60 of the injector assembly 10a. Similarly, the flange 74 of the second section 28 of the reactor conduit is attached to the front surface 66 of the spacer plate 60 of the injector assembly 10b. Gaskets 76 are disposed between each of the flanges 70 and 74 and the corresponding spacer plate 60 and between the front surfaces 66 of the spacer plates 60 of the injector assemblies 10a and 10b to assure a proper seal. Bolts 78 are extended through the openings 72 in the flange 70, corresponding openings 68 in the spacer plates 60 and corresponding openings 72 in the flange 74, and nuts 80 are threaded on to the bolts to attach the first and second sections 24 and 28 of the reactor conduit 16 to the spacer plates 60 and indirectly together. In this manner, the first and second sections 24 and 28 of the reactor conduit 16 are fluidly connected to the injector assemblies 10a and 10b and are indirectly connected together. The first and second sections 24 and 28 of the reactor conduit 16 and the injector conduits 30 of the assemblies 10a and 10b effectively become a single reactor conduit with the ports 42 spaced around the cross-sectional perimeter of the reactor conduit.

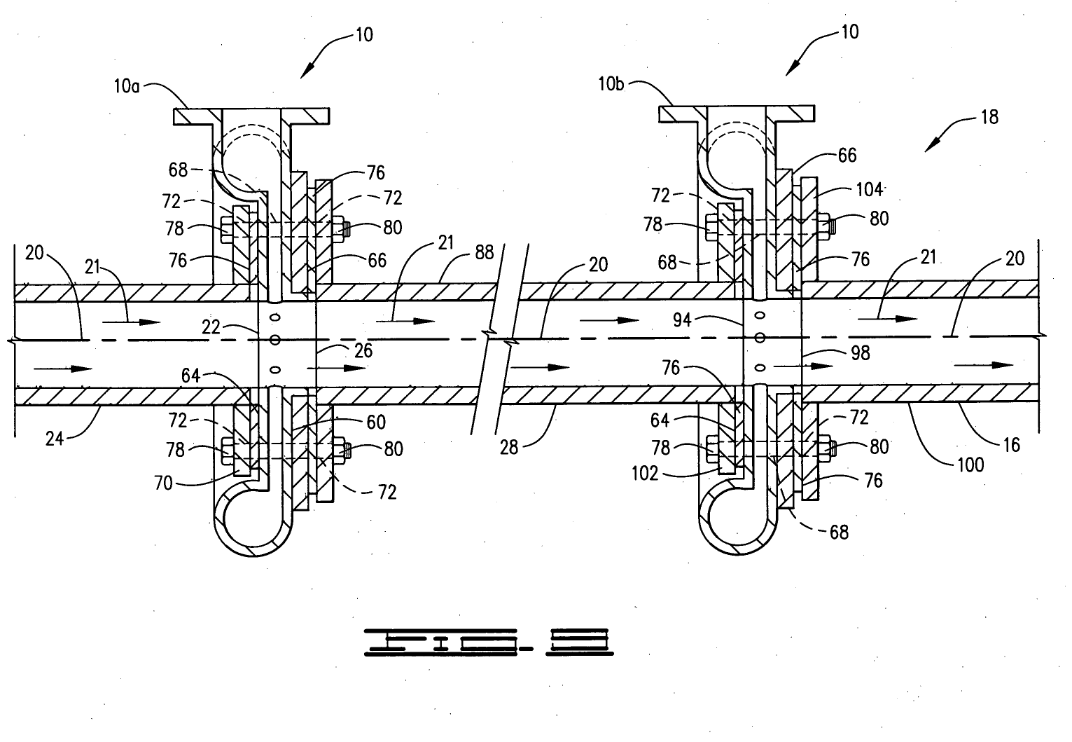

As another example, as shown by FIG. 9, two injector assemblies 10a and 10b are disposed in the reactor conduit 16 in a spaced relationship with respect to each other. The injector assembly 10a is disposed between the downstream end 22 of the first section 24 of the reactor conduit and the upstream end 26 of the second section 28 of the reactor conduit. The flange 70 of the first section 24 of the reactor conduit 16 is attached to the rear surface 64 of the spacer plate 60 of the injector assembly 10a. The flange 74 of the second section 28 of the reactor conduit 16 is attached to the front surface 66 of the injector assembly 10a. Gaskets 76 are disposed between each of the flanges 70 and 74 and the spacer plate 60 to assure a proper seal. Bolts 78 are extended through the openings 72 in the flange 70, corresponding openings 68 in the spacer plate 60 and corresponding openings 72 in the flange 74, and nuts 80 are threaded on to the bolts to attach the first and second sections 24 and 28 of the reactor conduit 16 to the spacer plate 60 and indirectly together. Similarly, the injector assembly 10b is disposed between the downstream end 94 of the second section 28 of the reactor conduit and the upstream end 98 of a third section 100 of the reactor conduit. A flange 102 of the second section 28 of the reactor conduit 16 is attached to the rear surface 64 of the spacer plate 60 of the injector assembly 10b. A flange 104 of the third section 100 of the reactor conduit 16 is attached to the front surface 66 of the injector assembly 10b. Gaskets 76 are disposed between each of the flanges 102 and 104 and the spacer plate 60 to assure a proper seal. Bolts 78 are extended through openings 72 in the flange 102, corresponding openings 68 in the spacer plate 60 and corresponding openings 72 in the flange 104, and nuts 80 are threaded on to the bolts to attach the second and third sections 28 and 100 of the reactor conduit 16 to the spacer plate 60 and indirectly together. In this manner, the first, second and third sections 24, 28 and 100 of the reactor conduit 16 are fluidly connected to the injector assemblies 10a and 10b and indirectly connected together. The first, second and third sections 24, 28 and 100 of the reactor conduit 16 and the injector conduits 30 of the assemblies 10a and 10b effectively become a single reactor conduit with the ports 42 spaced around the cross-sectional perimeter of the reactor conduit.

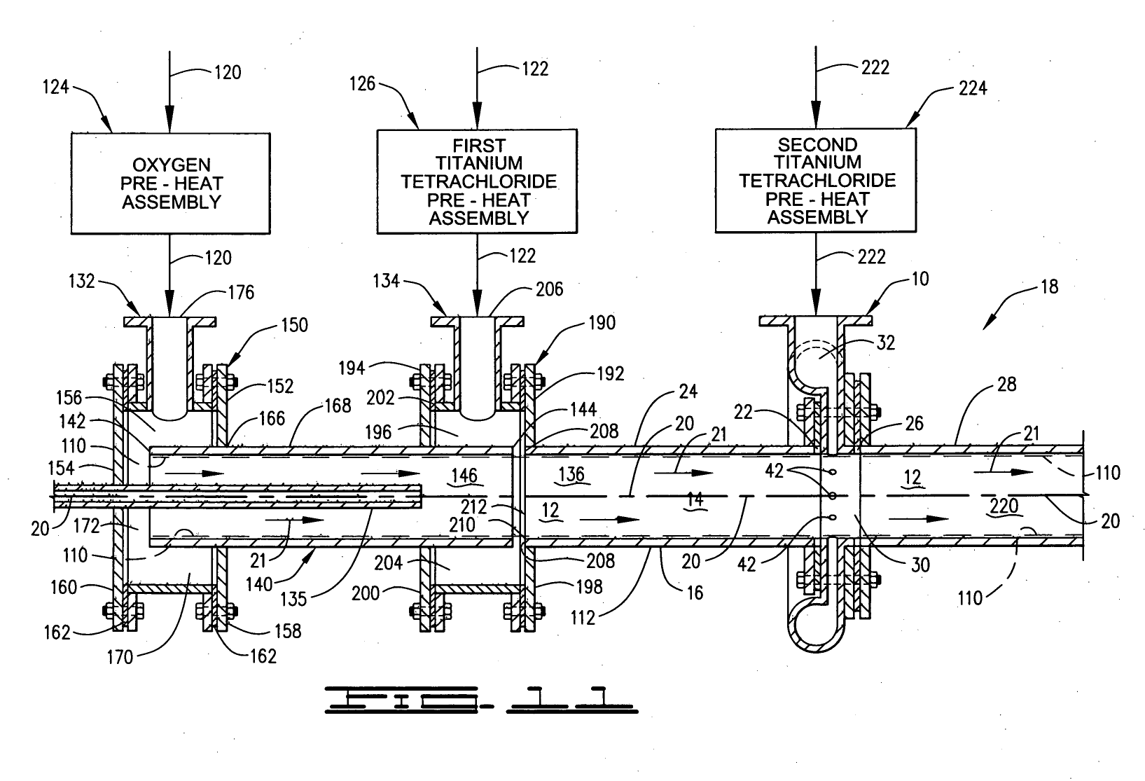

As understood by those skilled in the art, the inventive chemical reactor 18 can include other components as well. For example, as shown by FIG. 11 and discussed further below, in one illustrative embodiment, the reactor 18 comprises pre-heat assemblies 124 and 126 for pre-heating components for forming the component stream 12. Injector assemblies 132 and 134 are included for injecting the preheated components into the reactor conduit 16. An injection tube 135 is provided for directly introducing additional components into the component stream 12 along or generally along the longitudinal axis 20 of the reactor conduit 16.

Referring now to FIGS. 7 and 7A, the inventive chemical process is illustrated. One or more components are introduced into the reactor conduit 16 of the reactor 18 in a manner that causes the component(s) to flow as a component stream 12 through the reactor conduit along the longitudinal axis 20 thereof. An additional component is then transversely injected (as defined above) into the component stream 12. The additional component is transversely injected into the component stream 12 through a plurality of ports spaced around the cross-sectional perimeter 108 of the reactor conduit 16 (for example, the ports 42 of the inventive injector assembly 10 of the inventive chemical reactor 18). In one embodiment, the ports through which the additional component is injected into the component stream 12 are equally spaced (or at least approximately equally spaced) around the cross-sectional perimeter 108 of the reactor conduit 16.

The additional component is injected through the ports at a velocity sufficient to cause the additional component to significantly penetrate the outer boundary layer 110 of the component stream 12. In one embodiment, the additional component is injected through the ports at a velocity sufficient to cause the Natalie Number corresponding to the resulting component stream 12 (i.e., the component stream 12 after the injection of the additional component therein) to be in the range of from zero (0) to 0.5. In another embodiment, the additional component is injected through the ports at a velocity sufficient to cause the Natalie Number corresponding to the resulting component stream 12 to be 0.3 or less. As used and defined herein and in the appended claims, the Natalie Number corresponding to the resulting component stream 12 is determined at a point in the stream (the “point in question”) that is three pipe diameters (i.e., a distance that is three times the diameter of the reactor conduit 16) downstream of the point of injection of the additional component in the stream.

The Natalie Number represents or quantifies the variance between the concentration of a component at a point in a main stream and the theoretical concentration of the component at the same point in the main stream assuming that the component is perfectly mixed with the main stream at such point. Computational fluid dynamics is used to calculate the concentration C₁ at each of approximately 1000 locations spaced across the cross-sectional area. If the component is perfectly mixed with the main stream at the point in question, the variance will be zero (0). On the other hand, if the component is completely unmixed with the main stream at the point in question, the variance will be one (1).

Thus, the Natalie Number corresponding to the resulting component stream 12 at the point in question is reflective of the degree to which the additional component has penetrated the outer boundary layer 110 and mixed with the component stream 12. The Natalie Number (N_{Na}) corresponding to the resulting component stream 12 is determined in accordance with the following equation:

$${N}_{Na} = \frac{\int \int {( {C}_{avg} - {C}_{1} )}^{2} d x d y .}{{A ( {C}_{avg} )}^{2}}$$

wherein:
C_{avg}=the average concentration of the additional component at the point in question assuming that the additional component is completely mixed with the resulting component stream 12;
C₁=the actual concentration of the additional component at each of approximately 1000 locations spaced across the cross-sectional area; and
A=the cross-sectional area of the reactor conduit 16 at the point in question.
   Determination of the Natalie Number (N_{Na}) corresponding to the resulting component stream 12 is further illustrated by Example I below.

In one embodiment, the additional component is conducted to the ports in the reactor conduit 16 (such as the ports 42 of the injector assembly 10) from an outer chamber that extends around the outside 112 of the reactor conduit 16 along the cross-sectional perimeter 108 thereof (such as the outer chamber 32 of the injector conduit 10). The outer chamber 32 is a conduit extending around the outside 112 of the reactor conduit 16 along the cross-sectional perimeter 108 thereof in a direction that is perpendicular or at least approximately perpendicular to the longitudinal axis 20 of the reactor conduit 16 (such as the outer chamber 32 of the injector conduit 10 of the reactor 18). The additional component can be injected into the outer chamber in such a manner (for example, at a sufficient velocity) to cause the additional component to swirl through the outer chamber along the longitudinal axis thereof. Swirling the additional component through the outer chamber may help assure, for example, that the additional component enters all of the ports. The additional component injected into the component stream 12 can be a single reactant or other component or a combination of reactants and/or other components in vapor, liquid or slurry form.

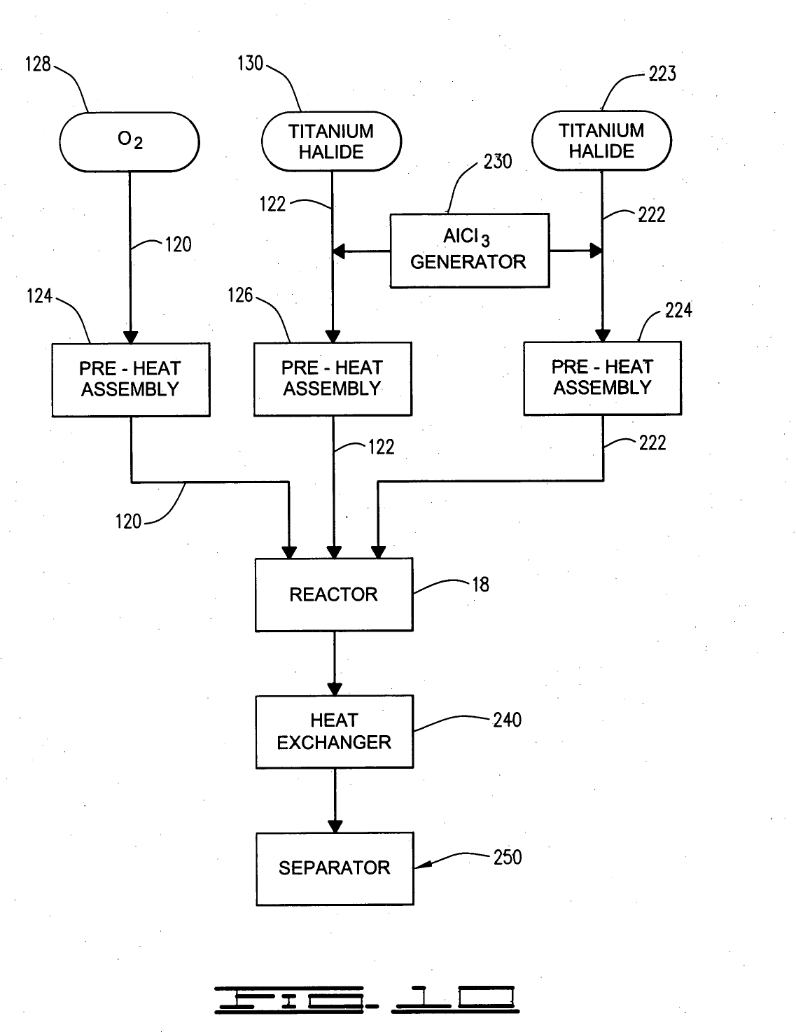

Referring now to FIGS. 10 and 11, a process for producing titanium dioxide in accordance with the inventive process will be described. A gaseous titanium halide (such as titanium tetrachloride) and oxygen are continuously reacted in the vapor phase in the reactor 18 to produce titanium dioxide particles and gaseous reaction products. A stream 120 of oxygen (O₂), or an oxygen-containing gas (the “oxygen gas stream 120”), is combined with a stream 122 of a gaseous titanium halide (the “titanium halide gas stream 122”) in the reactor 18 at a temperature of at least 700° C. (1292° F.).

Prior to being combined in the reactor 18, the oxygen gas stream 120 and titanium halide gas stream 122 are pre-heated, for example, in pre-heat assemblies 124 and 126, respectively. The pre-heat assemblies 124 and 126 can be, for example, shell and tube type component heaters. The oxygen gas stream 120 is conducted to pre-heat assembly 120 from a source 128 thereof and pre-heated to a temperature in the range of from about 60° F. to about 3400° F., typically to a temperature in the range of from about 100° F. to about 1930° F. therein. Similarly, the titanium halide gas stream 122 is conducted to pre-heat assembly 126 from a source 130 thereof and pre-heated to a temperature in the range of from about 250° F. to about 1800° F., typically to a temperature in the range of from about 275° F. to about 350° F. therein.

The pre-heated oxygen gas stream 120 and pre-heated titanium halide gas stream 122 are conducted from pre-heat assemblies 124 and 126 to injection assemblies 132 and 134, respectively, and introduced into a first reaction zone 136 of the reactor conduit 16 of the reactor 18 thereby. The streams 120 and 122 are introduced into the first reaction zone 136 by the injection assemblies 132 and 134 in a manner that causes the streams to flow as a combined reactant stream 12 through the reactor conduit 16 along the longitudinal axis 20 thereof.

As shown by FIG. 11, the injection assemblies 132 and 134 are connected together by a cylindrically shaped injection conduit 140. The injection conduit 140 includes an upstream end 142, a downstream end 144 and an injection conduit opening 146 extending axially therethrough.

The oxygen gas stream injection assembly 132 includes a cylindrically shaped case 150 having a downstream end 152, an opposite upstream end 154 and an opening 156 extending axially therethrough. A downstream end wall 158 is secured to the downstream end 152 and an upstream end wall 160 is secured to the upstream end 154 of the case 150. Gaskets 162 are positioned between the downstream end wall 158 and downstream end 142 and the upstream end wall 160 and upstream end 154 in order to assure a proper seal. The inner diameter formed by the opening 156 (i.e., the inner diameter of the case 150) is larger than the outer diameter of the injection conduit 140.

The upstream end 142 of the injection conduit 140 extends through a central portion 166 of the downstream end wall 158 so that a portion of the conduit 140, generally near the upstream end 142 thereof, is disposed within a portion of the opening 156 of the case 150 (i.e., within the interior of the case). The upstream end 142 of the injection conduit 140 is spaced a distance from the upstream end wall 160 of the case 150. The space between the inner wall formed by the opening 156 (i.e., the inner wall of the case 150) and the outside peripheral surface 168 of the injection conduit 140 forms a chamber 170. The space between the upstream end 142 of the injection conduit 140 and the upstream end wall 160 forms a slot 172 which allows for fluidic communication between the chamber 170 of the case 150 and the injection conduit opening 146 of the injection conduit 140.

The pre-heated oxygen gas stream 120 is conducted from the pre-heat assembly 124 to the chamber 170 of the case 150 through an inlet 176 in the case 150. The inlet 176 can be positioned with respect to the case 150 in an offset manner so that the oxygen gas stream is tangentially injected from the inlet into the chamber 170 to introduce a circular or swirling motion to the oxygen vapor stream in the chamber. The circular or swirling motion may help assure, for example, that the oxygen vapor uniformly enters the conduit opening 146 from around the circumference of the slot 172.

In the embodiment shown by FIG. 11, a separate injection tube 135 extends through the upstream end wall 160 and axially a distance into the center of the injection conduit 140. The injection tube 135 can be used to introduce additional components (for example, a scouring agent) into the reactant stream 12 formed in the reactor conduit 16 of the reactor 18.

The titanium halide gas stream injection assembly 134 includes a cylindrically shaped case 190 having a downstream end 192, an opposite upstream end 194 and an opening 196 extending axially therethrough. A downstream end wall 198 is secured to the downstream end 192, and an upstream end wall 200 is secured to the upstream end 194 of the case 190. Gaskets 202 are positioned between the downstream end wall 198 and downstream end 192 and the upstream end wall 200 and upstream end 194 in order to assure a proper seal. The inner diameter formed by the opening 196 (i.e., the inner diameter of the case 190) is larger than the outer diameter of the injection conduit 140.

The downstream end 144 of the injection conduit 140 extends through a central portion 202 of the upstream end wall 200 so that a portion of the conduit 140, generally near the downstream end 144 thereof, is disposed within a portion of the opening 196 of the case 190 (i.e., within the interior of the case). The downstream end 144 of the injection conduit 140 is spaced a distance from the downstream end wall 198 of the case 190. The space between the inner wall formed by the opening 196 (i.e., the inner wall of the case 190) and the outside peripheral surface 168 of the injection conduit 140 forms a chamber 204. The pre-heated titanium halide gas stream 122 is conducted from the pre-heat assembly 126 to the chamber 204 of the case 190 through an inlet 206 in the case 190.

An upstream end 208 of the first section 24 of the reactor conduit 16 of the reactor 18 extends through a central portion 210 of the downstream end wall 198 of the case 190. The upstream end 208 of the first section 24 of the reactor conduit 16 is spaced a distance axially from the downstream end 144 of the injection conduit 140, thereby forming a slot 212 in the chamber 204. The slot 212 provides fluidic communication between the chamber 204 and the conduit opening 14 of the first section 24 of the reactor conduit 16 of the reactor 18. As shown, the conduit opening 14 of the reactor conduit 16 is axially aligned with the injection conduit opening 146 of the injection conduit 140.

The inlet 206 can be positioned with respect to the case 190 in an offset manner so that the titanium halide vapor stream is tangentially injected from the inlet into the chamber 204 to introduce a circular or swirling motion to the vapor stream in the chamber. The circular or swirling motion may help assure, for example, that the titanium halide vapor uniformly enters the conduit opening 14 from around the circumference of the slot 212.

The first section 24 of the reactor conduit can have a frustoconical shape with the diameter of the section increasing from the upstream end 208 to the downstream end 22 thereof. The second and third sections 28 and 100 can have similar frustoconical shapes as well.

An additional component chosen from gaseous titanium halide and oxygen is introduced into a second reaction zone 220 in the reactor conduit 16 that is downstream of the first reaction zone 136. The additional component is transversely injected into the reactant stream 12 from a plurality of ports spaced around the cross-sectional perimeter 108 of the reactor conduit 16 at a velocity sufficient to cause the additional component to significantly penetrate the outer boundary layer 110 of the reactant stream 12. In one embodiment, the additional component is injected through the ports at a velocity sufficient to cause the Natalie Number corresponding to the resulting reactant stream 12 to be in the range of from zero (0) to 0.5. In another embodiment, the additional component is injected through the ports at a velocity sufficient to cause the Natalie Number corresponding to the resulting reactant stream 12 to be 0.3 or less. The Natalie Number corresponding to the resulting reactant stream 12 is defined and described above in connection with the inventive chemical process,

In one embodiment, the additional component is conducted to the ports in the reactor conduit 16 (such as the ports 42 of the injector assembly 10) from an outer chamber that extends around the outside 112 of the reactor conduit 16 along the cross-sectional perimeter 108 thereof. The outer chamber 32 is a conduit extending around the outside 112 of the reactor conduit 16 along the cross-sectional perimeter 108 thereof in a direction that is perpendicular or at least approximately perpendicular to the longitudinal axis 20 of the reactor conduit 16. The additional component can be injected into the outer chamber in such a manner (for example, at a sufficient velocity) to cause the additional component to swirl through the outer chamber along the longitudinal axis thereof. Swirling the additional component through the outer chamber helps assure, for example, that the additional component enters all of the ports.

As shown by FIG. 11, the additional component is transversely injected into the reactant stream 12 by the inventive injector assembly 10. The additional component is transversely injected into the reactant stream 12 from the ports 42 of the injector assembly 10. The additional component is conducted to the ports 42 from the outer chamber 32 of the injector conduit 10.

The injector assembly 10 is spaced downstream of the first reaction zone 136. As shown by FIGS. 7 and 11 and discussed above, the injector assembly 10 is disposed between the downstream end 22 of the first section 24 of the reactor conduit 16 and the upstream end 26 of the second section 28 of the reactor conduit, thereby fluidly connecting the first and second sections of the reactor conduit together. The manner by which the inventive injector assembly 10 transversely injects the additional component into the reactant stream 12 is described above.

In one embodiment, the additional component is chosen from gaseous titanium halide, oxygen and a mixture thereof. The additional titanium halide and/or oxygen react with unreacted titanium halide and/or oxygen from the first reaction zone 136 and thereby increase the capacity of the process. As shown by the drawings, the additional component is additional titanium tetrachloride. A stream 222 of the additional titanium halide is pre-heated in a pre-heat assembly 224 and injected into the second reaction zone 220 by the inventive injector assembly 10. The titanium halide gas stream 222 is conducted to the pre-heat assembly 224 from a source thereof (not shown) and pre-heated to a temperature in the range of from about 250° F. to about 1800° F., typically to a temperature in the range of from about 275° F. to about 350° F. therein.

Titanium halide and oxygen are allowed to react in the vapor phase in the first reaction zone 136 and/or second reaction zone 220 of the reactor conduit 16 to form titanium dioxide particles and gaseous reaction products. The combined reactant steam flows through the reactor conduit 16, for example, at a velocity at a range of from about 100 feet/second to about 800 feet/second. At a pressure of 1 atmosphere (absolute), the oxidation reaction temperature is typically in the range of from about 2300° F. to about 2500° F. The pressure at which the oxidation is carried out can vary widely. For example, the oxidation reaction can be carried out at a pressure in the range of from about 3 psig to about 50 psig.

The titanium halide reactant can be any of the known halides of titanium, including titanium tetrachloride (TiCl₄), titanium tetrabromide, titanium tetraiodide and titanium tetraflouride. A very suitable titanium halide is titanium tetrachloride. Titanium tetrachloride is the titanium halide of choice in most, if not all, vapor phase oxidation processes for producing rutile titanium dioxide pigment. It is oxidized to produce particulate solid titanium dioxide and gaseous reaction products in accordance with the following reaction:

TiCl₄+O₂→TiO₂+2Cl₂

In one embodiment, the additional component injected into the combined reactant stream 12 is additional titanium halide. The titanium halide introduced into the first and second reaction zones 136 and 220 of the reactor conduit 16 can be titanium tetrachloride.

The oxygen-containing gas reactant is preferably molecular oxygen. However, it can also consist of, for example, oxygen in a mixture with air (oxygen enriched air). The particular oxidizing gas employed will depend on a number of factors including the size of the reaction zones 136 and 220 within the reactor conduit 16, the degree to which the titanium halide and oxygen-containing gas reactants are pre-heated, the extent to which the surfaces of the reaction zones are cooled and the throughput rate of the reactants in the reaction zones.

While the exact amounts of titanium halide and oxidizing gas reactants employed can vary widely and are not particularly critical, it is important that the oxygen-containing gas reactant be present in an amount at least sufficient to provide for a stoichiometric reaction with the titanium halide. Generally, the amount of the oxygen-containing gas reactant employed will be an amount in excess of that required for a stoichiometric reaction with the titanium halide reactant, for example, from about 5% to about 25% in excess of that required for a stoichiometric reaction.

In addition to the titanium halide and oxidizing gas reactants, it is often desirable to introduce other components into the reactor 18 for various purposes. For example, in one embodiment, alumina is introduced into the reactor 18 in a predetermined amount that is sufficient to promote rutilization of the titanium dioxide. The amount of alumina needed to promote rutilization of the titanium dioxide varies depending on numerous factors known to those skilled in the art. Generally, the amount of alumina required to promote rutilization is in the range of from about 0.3% to about 1.5% by weight, based on the weight of the titanium dioxide particles being produced. A typical amount of alumina introduced into the reaction zone 16 is 1.0% by weight based on the weight of the titanium dioxide being produced.

In one embodiment, alumina is introduced into the reaction zone 16 of the reactor 18 by combining aluminum chloride with the oxygen gas stream 120, the titanium halide stream 122 and/or the additional titanium halide stream 222. As shown by the drawings, the aluminum chloride is combined with one or both of the titanium halide streams 122 and 222. The aluminum chloride is generated on site in an aluminum chloride generator 230 that is in fluid communication with one or both of the titanium halide stream 122 and the titanium halide stream 222. Various types of aluminum chloride generators are well known in the art and can be used in the process of the invention. For example, powdered aluminum, with or without an inert particulate material, can be fluidized in the reactor by the upward passage of reactant chlorine and/or an inert gas. Alternatively, aluminum can be introduced into a stream of chlorine gas in particulate form but not necessarily sufficiently finely divided to fluidize in the gas stream. A fixed bed of particulate aluminum can be chlorinated by passing chlorine to the bed through numerous nozzles surrounding the bed.

An example of another component that can be advantageously introduced into the reactor 18 is a scouring agent. The scouring agent functions to clean the walls of the reactor and prevent fouling thereof. Examples of scouring agents which can be used include, but are not limited to, sand, mixtures of titanium dioxide and water which are pelletized, dried and sintered, compressed titanium dioxide, rock salt, fused alumina, titanium dioxide, salt mixtures and the like.

The titanium dioxide particles and gaseous reaction products that are formed in the reactor 18 are cooled by heat exchange with a cooling medium (such as cooling water) in a tubular heat exchanger 240 to a temperature of about 1300° F. A scouring agent can also be injected into the heat exchanger 240 to remove deposits of titanium dioxide and other materials from the inside surfaces of the heat exchange. The same types of scouring agents that are used in the reactor 18 can be used in the heat exchanger 240.

After passing through the heat exchanger 240, the particulate solid titanium dioxide is separated from the gaseous reaction products and any scouring agent(s) in separation apparatus 250.

The titanium dioxide manufactured in accordance with the inventive process is very suitable for use as a pigment.

### EXAMPLE

This prophetic example is provided in order to further illustrate the invention.

The inventive process for producing titanium dioxide, as described above and illustrated by FIGS. 10 and 11, is carried out. The inventive chemical reactor 18 is used in the process. A pre-heated oxygen gas stream 120 and pre-heated titanium tetrachloride gas stream 122 are introduced into the first reaction zone 136 of the reactor conduit 16 of the reactor 18 in a manner that causes the streams to flow as a combined reactant stream 12 through the reactor conduit 16 along the longitudinal axis 20 thereof. The flow rate of the combined reactant stream 12 through the reactor conduit 16 is 2.5 kilograms per second. The temperature of the combined reactant stream 12 is 1300 degrees Kelvin. The diameter of the reactor conduit 16 is seven (7) inches.

Additional oxygen is then introduced into the second reaction zone 220 by the injector assembly 10. The injector assembly 10 includes eight ports 42 equally spaced around the cross-sectional perimeter 44 of the injector conduit wall 38, each port having a diameter of 0.622 inches. The additional oxygen is swirled through the outer chamber 32 and transversely injected through the ports 42 into the reactant stream 12 at a velocity of 0.189 kilograms per second. The temperature of the additional oxygen is 300 degrees Kelvin. The pressure drop across the injector assembly 10 during injection of the additional oxygen is 4.4 psig.

The velocity at which the additional oxygen is transversely injected through the ports 42 into the reactant stream 12 is sufficient to cause the additional oxygen to significantly penetrate the outer boundary layer 110 of the reactant stream 12. The velocity at which the additional oxygen is transversely injected through the ports 42 into the reactant stream 12 is also sufficient to cause the Natalie Number corresponding to the resulting reactant stream to be 0.3. The Natalie Number corresponding to the resulting reactant stream 12 is determined at a point in the reactant stream (the “point in question”) that is three pipe diameters downstream of the point of injection of the additional oxygen into the reactant stream by the injector assembly 10. The Natalie Number (N_{Na}) is determined in accordance with the equation set forth below.

$${N}_{Na} = \frac{\int \int {( {C}_{avg} - {C}_{1} )}^{2} d x d y .}{{A ( {C}_{avg} )}^{2}}$$

wherein:
C_{avg}=0.07, which is the average concentration of the additional oxygen at the point in question assuming that the additional oxygen gas is completely mixed with the resulting reactant stream 12;
C₁ ranges from 0 to 1, which is the actual concentration of the additional oxygen determined at approximately 1000 locations spaced across the cross-sectional area A using computational fluid dynamics; and
A=38.5 square inches, which is the cross-sectional area of the reactor conduit 16 at the point in question.

Thus, the present invention is well adapted to carry out the objects and attain the ends and advantages mentioned as well as those which are inherent therein.

What is claimed is:

1. An injector assembly for injecting an additional component into a component stream flowing through the conduit opening of a reactor conduit along the longitudinal axis thereof, said assembly being attachable between the downstream end of a first section of the reactor conduit and the upstream end of a second section of the reactor conduit in a manner that fluidly connects the first and second sections of the reactor conduit together, said assembly comprising:
an injector conduit having an upstream end, a downstream end and an injector conduit wall disposed between said upstream end and downstream end and defining an injector conduit opening that can be aligned to be in fluid communication with the conduit openings of the first and second sections of the reactor conduit, said injector conduit wall including at least one port extending therethrough for transversely injecting the additional component into the component stream in the reactor conduit; and
an outer chamber extending around the outside of said injector conduit wall along the cross-sectional perimeter thereof and in fluid communication with said port, said outer chamber including an inlet for receiving the additional component from a source of the additional component.

2. The injector assembly of claim 1, wherein said injector conduit wall includes a plurality of ports extending therethrough for transversely injecting the additional component into the component stream in the reactor conduit, and said outer chamber is in fluid communication with each of said ports.

3. The injector assembly of claim 2, wherein said ports are spaced around the cross-sectional perimeter of said injector conduit wall.

4. The injector assembly of claim 1, wherein said assembly further comprises a spacer plate disposed between said injector conduit and said outer chamber, said spacer plate including a passageway disposed between said port and said outer chamber and fluidly connecting said port and said outer chamber together.

5. The injector assembly of claim 2, wherein said assembly further comprises a spacer plate disposed between said injector conduit and said outer chamber, said spacer plate including a passageway disposed between each of said ports and said outer chamber, each of said passageways fluidly connecting said corresponding port and said outer chamber together.

6. The injector assembly of claim 3, wherein said injector conduit has a circular cross-sectional shape.

7. The injector assembly of claim 6, wherein said outer chamber is a conduit having a circular cross-sectional shape.

8. An injector assembly for injecting an additional component into a component stream flowing through the conduit opening of a reactor conduit along the longitudinal axis thereof, said assembly being attachable between the downstream end of a first section of the reactor conduit and the upstream end of a second section of the reactor conduit in a manner that fluidly connects the first and second sections of the reactor conduit together, said assembly comprising:
an injector conduit having an upstream end, a downstream end and an injector conduit wall disposed between said upstream end and said downstream end and defining an injector conduit opening that can be aligned to be in fluid communication with the conduit openings of the first and second sections of the reactor conduit, said injector conduit wall including a plurality of ports spaced around the cross-sectional perimeter thereof and extending therethrough for transversely injecting the additional component into the component stream in the reactor conduit; and
an outer chamber extending around the outside of said injector conduit wall along the cross-sectional perimeter thereof and in fluid communication with said ports, said outer chamber including an inlet for receiving the additional component from a source of the additional component.

9. The injector assembly of claim 8, wherein said assembly further comprises a spacer plate disposed between said injector conduit and said outer chamber, said spacer plate including a passageway disposed between each of said ports and said outer chamber, each of said passageways fluidly connecting said corresponding port and said outer chamber together

10. The injector assembly of claim 9, wherein said injector conduit has a circular cross-sectional shape.

11. The injection assembly of claim 10 wherein said outer chamber is a conduit having a circular cross-sectional shape.

12. A chemical reactor, comprising:
a reactor conduit for conducting a component stream in a flow path that is at least approximately parallel to the longitudinal axis of the reactor conduit, said reactor conduit including a first section and a second section, each of said first and second sections having an upstream end, a downstream end and a reactor conduit wall defining a reactor conduit opening disposed between said upstream and downstream ends; and
an injector assembly for injecting an additional component into the component stream, said assembly being disposed between said downstream end of said first section of said reactor conduit and said upstream end of said second section of said reactor conduit and fluidly connecting said first and second sections together, said assembly including:
an injector conduit having an upstream end, a downstream end and an injector conduit wall disposed between said upstream end and said downstream end and defining an injector conduit opening, said injector conduit opening being aligned with said conduit openings of said first and second sections of said reactor conduit and in fluid communication therewith, said injector conduit wall including at least one port extending therethrough for transversely injecting the additional component into the component stream; and
an outer chamber extending around the outside of said injector conduit wall along the cross-sectional perimeter thereof and in fluid communication with said port, said outer chamber including an inlet for receiving the additional component from a source of the additional component.

13. The reactor of claim 12, wherein said injector conduit wall includes a plurality of ports extending therethrough, and said outer chamber is in fluid communication with each of said ports.

14. The reactor of claim 13, wherein said ports are spaced around the cross-sectional perimeter of said injector conduit wall.

15. The reactor of claim 12, wherein said injector assembly further includes a spacer plate disposed between said injector conduit and said outer chamber, said spacer plate including a passageway disposed between said port and said outer chamber and fluidly connecting said port and said outer chamber together.

16. The reactor of claim 13, wherein said injector assembly further includes a spacer plate disposed between said injector conduit and said outer chamber, said spacer plate including a passageway disposed between each of said ports and said outer chamber, each of said passageways fluidly connecting said corresponding port and said outer chamber together.

17. The reactor of claim 16, wherein said reactor conduit including said first and second sections thereof and said injector conduit each have a circular cross-sectional shape.

18. The reactor of claim 17, wherein said outer chamber is a conduit extending around the outside of said injector conduit wall along the cross-sectional perimeter thereof and around said spacer plate in a direction that is at least approximately perpendicular to the longitudinal axis of said reactor conduit.

19. The reactor of claim 18, wherein said reactor conduit including said first and second sections thereof and said injector conduit are axially aligned together in at least an approximately straight path.

20. A chemical reactor, comprising:
a reactor conduit for conducting a component stream in a flow that is at least substantially parallel to the longitudinal axis of the reactor conduit, said reactor conduit including a first section and a second section, each of said first and second sections having an upstream end, a downstream end and reactor conduit wall defining a reactor conduit opening disposed between said upstream and downstream ends; and
an injector assembly for injecting an additional component into the component stream, said injector assembly being disposed between said downstream end of said first section of said reactor conduit and said upstream end of said second section of said reactor conduit and fluidly connecting the first and second sections together, said injector assembly including:
an injector conduit having an upstream end, a downstream end and an injector conduit wall disposed between said upstream end and said downstream end and defining an injector conduit opening, said injector conduit opening being aligned with said reactor conduit openings of said first and second sections of said reactor conduit and in fluid communication therewith, said injector conduit wall including a plurality of ports spaced around the cross-sectional perimeter thereof and extending therethrough for transversely injecting the additional component into the component stream; and
an outer chamber extending around the outside of said injector conduit wall along the cross-sectional perimeter thereof and in fluid communication with each of said ports, said outer chamber being a conduit that extends around the outside of said injector conduit wall along the cross-sectional perimeter thereof in a direction that is at least approximately perpendicular to the longitudinal axis of said reactor conduit and including an inlet for receiving the additional component from a source of the additional component.

21. The reactor of claim 20 wherein said injector assembly further includes a spacer plate disposed between said injector conduit and said outer chamber, said spacer plate including a passageway disposed between each of said ports and said outer chamber, each of said passageways fluidly connecting said corresponding port and said outer chamber together.

22. The reactor of claim 21, wherein said reactor conduit including said first and second sections thereof and said injector conduit each have a circular cross-sectional shape.

23. The reactor of claim 22, wherein said outer chamber has a circular cross-sectional shape.

24. The reactor of claim 23, wherein said reactor conduit including said first and second sections thereof and said injector conduit are axially aligned together in at least an approximately straight path.

25. A chemical process, comprising:
introducing one or more components into a reactor conduit in a manner that causes the component(s) to flow as a component stream through the reactor conduit along the longitudinal axis thereof; and
transversely injecting an additional component into said component stream through a plurality of ports spaced around the cross-sectional perimeter of said reactor conduit, said additional component being injected through said ports at a velocity sufficient to cause said additional component to significantly penetrate the outer boundary layer of said component stream.

26. The process of claim 25 wherein the additional component is injected into said component stream through said ports at a velocity sufficient to cause the Natalie Number corresponding to the resulting component stream to be in the range of from zero (0) to 0.5.

27. The process of claim 25 wherein the additional component is injected into said component stream through said ports at a velocity sufficient to cause the Natalie Number corresponding to the resulting component stream to be 0.3 or less.

28. The process of claim 25 wherein said additional component is conducted to said ports in said reactor conduit from an outer chamber, said outer chamber being a conduit that extends around the outside of said reactor conduit along the cross-sectional perimeter thereof in a direction that is at least approximately perpendicular to the longitudinal axis of said reactor conduit.

29. The process of claim 28 further comprising the step of swirling said additional component through said outer chamber along the longitudinal axis thereof.

30. A process for producing titanium dioxide, comprising:
introducing gaseous titanium halide and oxygen into a first reaction zone of a reactor conduit of a reactor in a manner that causes the titanium halide and oxygen to flow as a reactant stream through the reactor conduit along the longitudinal axis thereof;
introducing an additional component chosen from gaseous titanium halide, oxygen and a mixture thereof into a second reaction zone in said reactor conduit that is downstream of said first reaction zone, said additional component being transversely injected into said reactant stream from a plurality of ports spaced around the cross-sectional perimeter of said reactor conduit at a velocity sufficient to cause said additional component to significantly penetrate the outer boundary layer of said reactant stream;
allowing titanium halide and oxygen to react in the vapor phase in said first and/or second reaction zones of said reactor conduit to form titanium dioxide particles and gaseous reaction products; and
separating said titanium dioxide particles from said gaseous reaction products.

31. The process of claim 30 wherein the additional component is injected into said reactant stream through said ports at a velocity sufficient to cause the Natalie Number corresponding to the resulting reactant stream to be in the range of from zero (0) to 0.5.

32. The process of claim 30 wherein the additional component is injected into said reactant stream through said ports at a velocity sufficient to cause the Natalie Number corresponding to the resulting reactant stream to be 0.3 or less.

33. The process of claim 30 wherein said additional component is conducted to said ports in said reactor conduit from an outer chamber, said outer chamber being a conduit that extends around the outside of said reactor conduit along the cross-sectional perimeter thereof in a direction that is at least approximately perpendicular to the longitudinal axis of said reactor conduit.

34. The process of claim 33, further comprising the step of swirling said additional component through said outer chamber along the longitudinal axis thereof.

35. The process of claim 30 wherein said additional component is additional titanium halide.

36. The process of claim 35 wherein said titanium halide introduced into said first and second reaction zones of said reactor conduit is titanium tetrachloride.
